(19) United States
(12) Patent Application Publication
(10) Pub. No.: US 2017/0363026 A1
(43) Pub. Date: Dec. 21, 2017

(54) METHODS AND SYSTEMS FOR OPERATING AN ENGINE

(71) Applicant: Caterpillar Inc., Peoria, IL (US)

(72) Inventors: Lane Slabaugh, Lebanon, IN (US); Michael Kenning, Zionsville, IN (US); Rodney D. Harms, Bartonville, IL (US)

(73) Assignee: Caterpillar Inc., Peoria, IL (US)

(21) Appl. No.: 15/186,670

(22) Filed: Jun. 20, 2016

(51) Int. Cl. F02D 41/08; F02D 41/06; F02D 41/04; F02D 41/02; F02D 41/22; F02B 33/40

(52) U.S. Cl. CPC F02D 41/086; F02D 41/22; F02D 41/083; F02B 33/40; F02D 41/042; F02D 41/0215; F02D 41/065

(57) ABSTRACT

A method for operating an engine is disclosed. The method includes activating an engine idling reduction mode. The engine is shut down when the engine idling mode is active and when a measure of at least one first parameter, associated with each of one or more components coupled to the engine, is in respective predetermined ranges. The one or more components comprise at least a transmission assembly. The at least one first parameter corresponds to a temperature of oil in the transmission assembly. The engine is started when the engine idling mode is active and when the measure of the at least one first parameter, associated with at least one of the one or more components, is less than predetermined threshold values.

### TECHNICAL FIELD

The present disclosure relates to an engine. More particularly, the present disclosure relates to methods and systems for operating the engine in order to reduce engine idling.

### BACKGROUND

Engines have found their application in various fields such as, but not limited to, power generation, mining applications, infrastructure based applications, and well service applications. Further, the engines are utilized to perform various tasks, when operating in the aforementioned fields. During the execution of such tasks, there may exist a time period where the engine operates without any load and thus is idling. During idling, the engine continues to consume fuel.

U.S. Pat. No. 9,181,915 ('915 reference) discloses a vehicle power management system. The vehicle power management system shuts down the engine, when the engine power is not needed. The vehicle power management system determines whether a battery charge and a coolant temperature are in a predetermined range. If the battery charge and the coolant temperature are in the predetermined range, the engine is shut down. The engine is restarted when the coolant temperature or the battery charge dips below respective threshold values. Shutting down and restarting the engine based on the coolant temperature and the battery charge may ignore other conditions that are required to take into account to shut down/restart the engine.

### SUMMARY OF THE INVENTION

Various aspects of the present disclosure disclose a method for operating an engine. The method includes activating an engine idling reduction mode. The engine is shut down when the engine idling mode is active and when a measure of at least one first parameter, associated with each of one or more components coupled to the engine, is in respective predetermined ranges. The one or more components comprise at least a transmission assembly. The at least one first parameter corresponds to a temperature of oil in the transmission assembly. The engine is started when the engine idling mode is active and when the measure of the at least one first parameter, associated with at least one of the one or more components, is less than predetermined threshold values.

Various aspects of the present disclosure disclose an engine system. The engine system comprises an engine. Further, the engine system comprises one or more components coupled to the engine. Furthermore, the engine system comprises a controller that is configured to activate an engine idling reduction mode. The controller further shuts down the engine when the engine idling reduction mode is active and when a measure of at least one first parameter, associated with each of the one or more components, is in respective predetermined ranges. The one or more components comprise at least a transmission assembly, and the at least one first parameter corresponds to a temperature of oil in the transmission assembly. The controller further starts the engine when the engine idling reduction mode is active and when the measure of the at least one first parameter, associated with at least one of the one or more components, is less than predetermined threshold values.

Various aspects of the present disclosure disclose an engine idling reduction system. The engine idling reduction system comprises one or more first sensors configured to determine a measure of at least one first parameter associated with one or more components coupled to an engine. The one or more components comprise at least a transmission assembly. The at least one first parameter corresponds to at least a measure of a temperature of oil in the transmission assembly. The engine idling reduction system further comprises a controller configured to activate an engine idling reduction mode. The controller is further configured to shut down the engine when the engine idling reduction mode is active and when the measure of the at least one first parameter, associated with each of the one or more components, is in respective predetermined ranges. Additionally, the controller is further configured to start the engine when the measure of the at least one first parameter, associated with at least one of the one or more components, is less than predetermined threshold values.

### BRIEF DESCRIPTION OF THE DRAWINGS

FIG. 1 illustrates a diagrammatic illustration of an engine system, in accordance with the concepts of the present disclosure;

FIG. 2 illustrates a schematic of an engine idling reduction system, in accordance with the concepts of the present disclosure;

FIGS. 3a, 3b, and 3c illustrate a flowchart of a method for operating an engine, in accordance with the concepts of the present disclosure; and

FIG. 4 is a state diagram illustrating various states of operation of the engine, in accordance with the concepts of the present disclosure.

### DETAILED DESCRIPTION

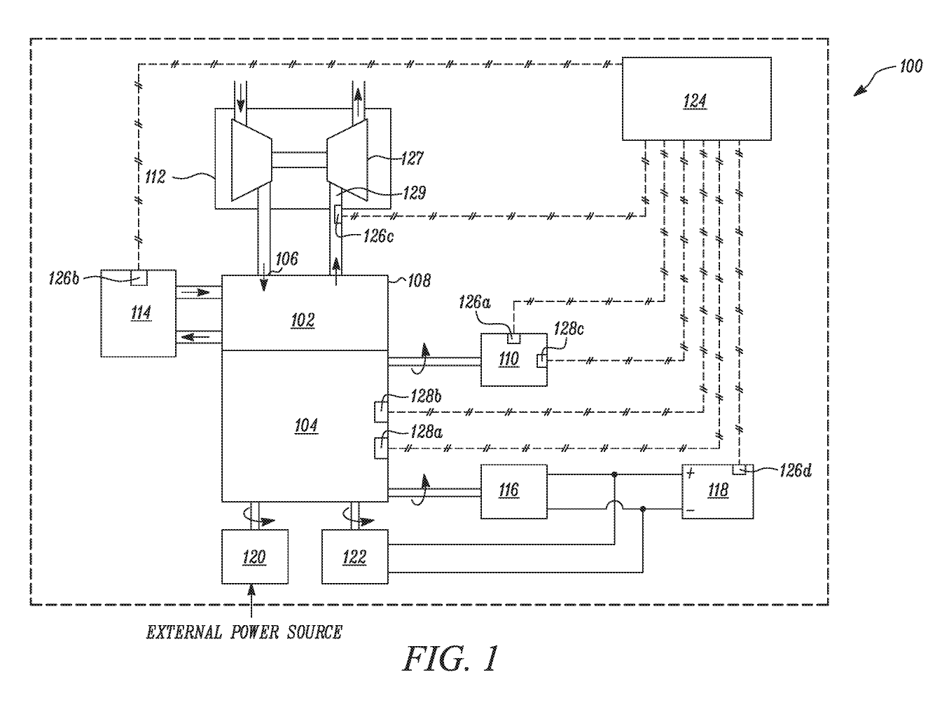

Referring to FIG. 1, an engine system 100 is illustrated. The engine system 100 includes an engine 102 having a crankcase 104, an inlet port 106, and an exhaust port 108. Further, the engine system 100 includes a transmission assembly 110, a turbocharger 112, an engine cooling unit 114, a voltage source such as a battery 116, an alternator 118, a first starter motor 120, a second starter motor 122, and an engine idling reduction system 124. The engine idling reduction system 124 includes one or more first sensors 126a, 126b, 126c, and 126d, and one or more second sensors 128a, 128b, and 128c. In an embodiment, the transmission assembly 110, the turbocharger 112, the engine-cooling unit 114, and the battery 116, correspond to one or more components coupled to the engine 102.

The engine 102 may be based on one of the commonly applied power-generation units, such as an internal combustion engine (ICE). The engine 102 may include a V-type engine, in-line engine, or an engine with different configurations, as is conventionally known. Although not limited, the engine 102 may be a spark-ignition engine or a compression ignition engine, which may be applied in construction machines or locomotives. However, aspects of the present disclosure, need not be limited to a particular engine type. In an embodiment, during engine operation, exhaust gases are released through the exhaust port 108.

The crankcase 104 includes a housing that encloses a crankshaft. The crankshaft is connected to the piston (in the engine 102) through a connecting rod. In an embodiment, the piston is connected to the crankshaft in such a manner that the reciprocating motion of the piston is converted into the rotary motion of the crankshaft. The rotary motion of the crankshaft is transferred to the alternator 118 and the transmission assembly 110.

In an embodiment, the transmission assembly 110 includes a plurality of gears. Each gear in the plurality of gears has a predetermined ratio. For example, if the transmission assembly 110 includes a first gear having a first ratio and a second gear having a second ratio. In an embodiment, the ratio of the gear is deterministic of an amount of torque and speed to be transferred from the engine 102 to equipment coupled to the engine 102. In an embodiment, a gear from the plurality of gears may be engaged based on an input received from an operator of the engine 102. For example, if the gear engaged in the transmission assembly 110 is a neutral gear, zero torque or speed is transferred to the connected equipment. If the gear engaged is any gear other than the neutral gear, a predetermined torque is transferred to the equipment. The ratio of the gear determines the amount of the predetermined torque. In an embodiment, the transmission assembly 110 may further include brakes that is configured to stop the rotation of an output shaft of the transmission assembly 110. The transmission assembly 110 may correspond to a manual transmission assembly, an automatic transmission assembly, or a semi-automatic transmission assembly, without departing from the scope of the disclosure. The transmission assembly 110 may further include oil that is circulated through the transmission assembly 110 for lubrication of the plurality of gears.

The turbocharger 112 includes a turbine 127 and a compressor. The turbine 127 receives the exhaust gases from the engine 102 through the exhaust port 108. In an embodiment, the turbine 127 includes an inlet 129 that is configured to receive the exhaust gases from the engine 102. The exhaust gases cause the turbine 127 to rotate, which in turn operates the compressor of the turbocharger 112. The compressor sucks and compresses the air from the environment and provides the compressed air into the engine 102 through the inlet port 106.

The engine-cooling unit 114 is configured to cool the engine 102 using liquid coolant. The coolant is circulated around the engine 102. In an embodiment, the heat generated in the engine 102, due to the combustion of the fuel, is transferred to the coolant. Further, the engine-cooling unit 114 includes a heat exchanger, such as a radiator, which facilitates the dissipation of the heat of the coolant into the atmosphere. In an embodiment, the engine cooling unit 114 may further include a water jacket (not shown) disposed around the transmission assembly 110. A tube cooler (not shown) coupled to the water jacket may be utilized to transfer heat from the transmission assembly 110 to the engine 102.

The battery 116 corresponds to a voltage source that is configured to provide electrical energy to operate various electrical equipment of the of the engine system 100. For example, the battery 116 operates the second starter motor 122 for cranking the engine 102. In an embodiment, the alternator 118 charges the battery 116 using the engine's power. In an embodiment, the battery 116 may be realized through a lead-acid type battery. However, other types of batteries that are capable of operating the electrical equipment in the machine may be contemplated.

The first starter motor 120 is coupled to the crankshaft. The first starter motor 120 is configured to start the engine 102. In an embodiment, the first starter motor 120 is operated using an external power source (i.e., power source outside the engine system 100). The first starter motor 120 rotates the crankshaft in order to start the engine 102. In an embodiment, the first starter motor 120 may correspond to a pneumatic starter motor or a hydraulic starter motor. In an embodiment, when the first starter motor 120 corresponds to the hydraulic starter motor, the external power source utilized to operate the first starter motor 120 is a wet kit. In an embodiment, the wet kit corresponds to a machine that drives the first starter motor 120 using pressurized liquid. In alternate embodiment, when the first starter motor 120 corresponds to the pneumatic starter motor, the first starter motor 120 is operated using compressed air stored in an accumulator. In some embodiments, the first starter motor 120 may correspond to a combination of the pneumatic starter motor and the hydraulic starter motor. In another embodiment, the first starter motor 120 may be a spinning inertia based starter motor.

In an embodiment, the second starter motor 122 is coupled to the crankshaft in a similar manner in which the first starter motor 120 is coupled to the crankshaft. In an embodiment, the second starter motor 122 corresponds to an electric starter motor that receives power from the battery 116 to rotate the crankshaft and thus to start the engine 102.

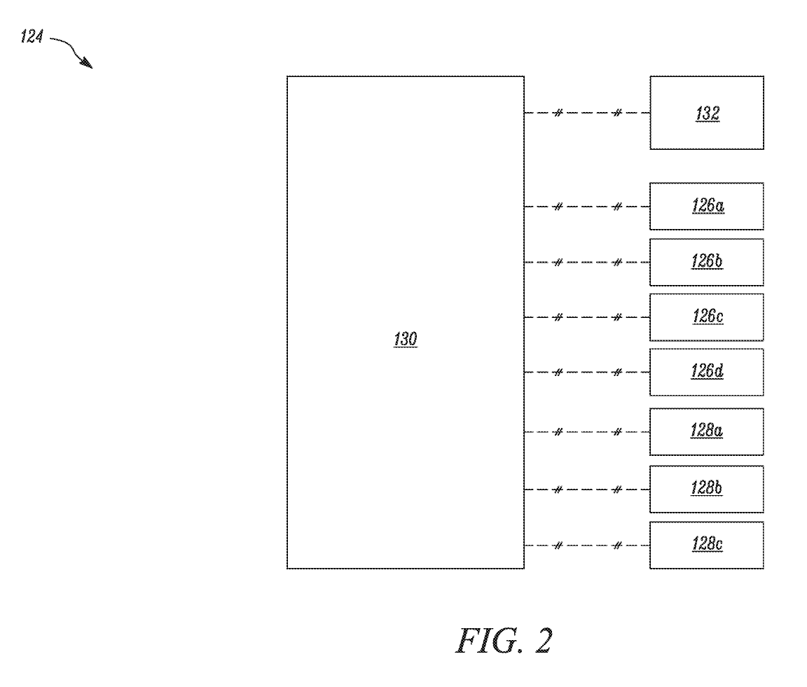

Referring to FIG. 1 and FIG. 2, the engine idling reduction system 124 includes the one or more first sensors 126a, 126b, 126c, and 126d, and the one or more second sensors 128a, 128b, and 128c, a controller 130, and an alarm device 132.

The one or more first sensors 126a, 126b, 126c, and 126d are configured to determine a measure of at least one first parameter (hereinafter referred to as the first parameter) associated with each of the one or more components coupled to the engine 102. As discussed supra, the one or more components comprise the transmission assembly 110, the turbocharger 112, the engine-cooling unit 114, and the battery 116. Therefore, the one or more first sensors 126a, 126b, 126c, and 126d determine the measure of the first parameter associated with each of the transmission assembly 110, the turbocharger 112, the engine-cooling unit 114, and the battery 116. In an embodiment, the first parameter corresponds to a temperature of the coolant in the engine cooling unit 114, a temperature of the inlet 129 of the turbine 127 in the turbocharger 112, a temperature of the oil in the transmission assembly 110, and a state of charge (SOC) of the battery 116. In an embodiment, each of the first sensors 126a, 126b, and 126c correspond to a temperature sensor that is used to determine the measure of the temperature of the oil in the transmission assembly 110, the temperature of the coolant in the engine cooling unit 114, and the temperature of the inlet 129 of the turbine 127 in the turbocharger 112, respectively. In an embodiment, the temperature sensor may be realized through any known technologies such as, but not limited to, a thermistor, a thermocouple, and a silicon bandgap temperature sensor. In an embodiment, the first sensor 126d is configured to determine the measure of the SOC of the battery 116.

In some embodiments, the one or more first sensors 126a, 126b, 126c, and 126d may be installed in the equipment that is external to the engine system 100. For example, the one or more first sensors 126a, 126b, 126c, and 126d may be installed in the equipment that is driven by the engine 102 and that is external to the engine system 100. In an embodiment, a type of the equipment may be determined based on the field in which the engine system 100 is being used. For instance, if the field in which the engine system 100 is being used is a well service application, one of the equipment that is driven by the engine 102 may correspond to a frac pump. In such a scenario, the one or more first sensors 126a, 126b, 126c, and 126d may be installed in the frac pump to determine the first parameter associated with the frac pump. Further, the first parameter associated with the frac pump may include at least one of a temperature of the frac pump or a hydraulic pressure in the frac pump. Further, to measure the temperature and the hydraulic pressure the one or more first sensors 126a, 126b, 126c, and 126d may include a temperature sensor and a pressure sensor, respectively.

The one or more second sensors 128a, 128b, and 128c are configured to determine a measure of one or more second parameters associated with the engine 102 and the one or more components. In an embodiment, the second sensor 128a is installed on the crankshaft in the crankcase 104. In an embodiment, the second sensor 128a is configured to measure the speed of the engine 102. In an embodiment, the second sensor 128b is utilized to determine a measure of load on the engine 102. In some embodiments, the load on the engine 102 may be determined by the controller 130 using conventional methods. Further, the second sensor 128c is installed in the transmission assembly 110 and is configured to determine the gear, of the plurality of gears, which is engaged in the transmission assembly 110. Further, the second sensor 128c is configured to monitor a state of the brakes. For instance, the second sensor 128c may determine whether the brakes are in a locked state (i.e., brakes are stopping the rotation of the output shaft of the transmission assembly 110). In an embodiment, the state of the brakes additionally constitutes the one or more second parameters.

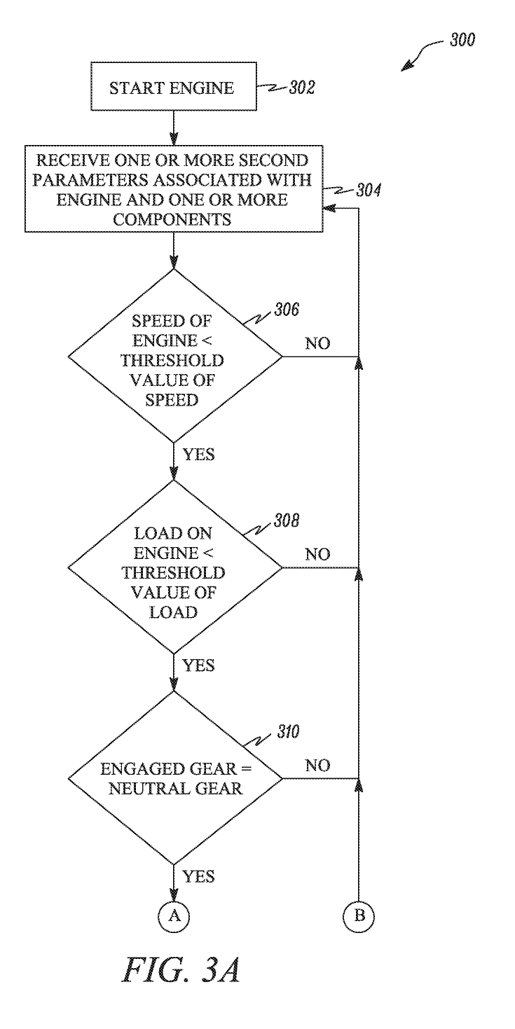

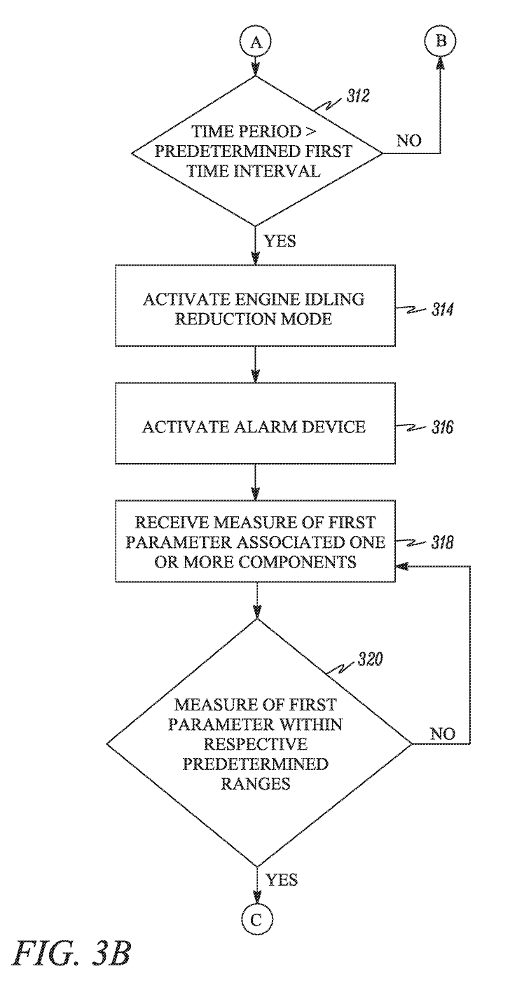

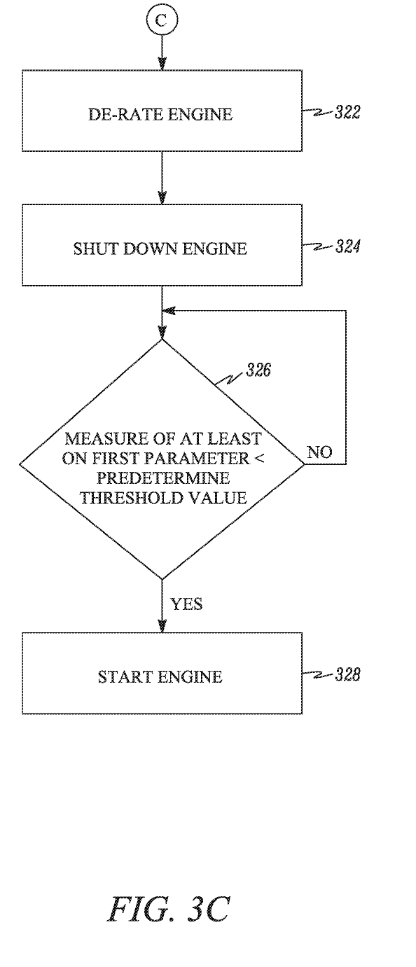

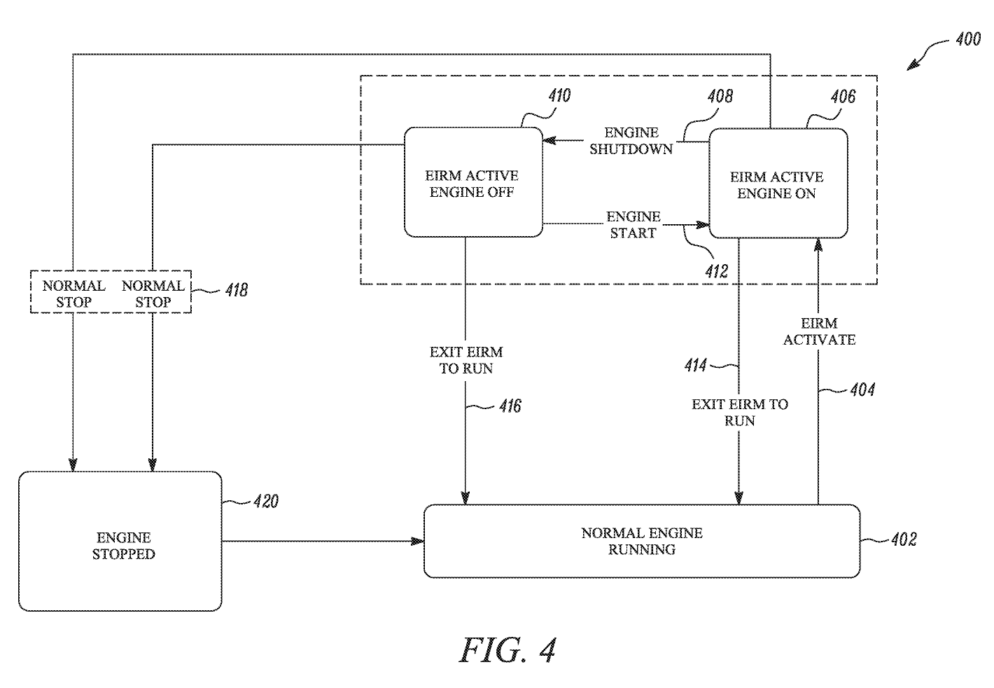

In an embodiment, the controller 130 is configured to control the engine 102. The controller 130 is communicatively coupled to the one or more first sensors 126a, 126b, 126c, and 126d, the one or more second sensors 128a, 128b, and 128c, and the alarm device 132, through wired or wireless connection. In an embodiment, the controller 130 may receive the measure of the first parameter and the measure of the one or more second parameters from the one or more first sensors 126a, 126b, 126c, and 126d, the one or more second sensors 128a, 128b, and 128c. In an embodiment, the controller 130 is configured to control the operation of the engine 102 based on the measure of the first parameter and the measure of the one or more second parameters. The process of operating the engine 102 has been described later in conjunction with FIGS. 3a, 3b, 3c, and FIG. 4. In an embodiment, the controller 130 may correspond to an Engine Control Unit (ECU). In an embodiment, the functionalities of the controller 130 may be implemented on an application server (not shown) installed at a remote location. The controller 130 includes a processor, a memory device, and a transceiver.

The processor includes suitable logic, circuitry, interfaces, and/or code that may be configured to execute a set of instructions stored in the memory device. The processor may be implemented based on a number of technologies known in the art. The processor may work in coordination with the one or more first sensors 126a, 126b, 126c, and 126d, and the one or more second sensors 128a, 128b, and 128c, the memory device, and the transceiver. Examples of the processor include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory device includes suitable logic, circuitry, interfaces, and/or code that may be configured to store the set of instructions, which are executed by the processor. In an embodiment, the memory device may be configured to store one or more programs, routines, or scripts that may be executed in coordination with the processor. The memory device may be implemented based on a Random Access Memory (RAM), a Read-Only Memory (ROM), a Hard Disk Drive (HDD), a storage server, and/or a Secure Digital (SD) card.

The transceiver includes suitable logic, circuitry, interfaces, and/or code that may be configured to receive data from the one or more first sensors 126a, 126b, 126c, and 126d, and the one or more second sensors 128a, 128b, and 128c. The transceiver may implement one or more known technologies to support wired or wireless communication with the one or more first sensors 126a, 126b, 126c, and 126d, and the one or more second sensors 128a, 128b, and 128c. Some examples of the known technologies include, but are not limited to, I2C communication protocol, Bluetooth®, ZigBee®, and SSI®. In an embodiment, the transceiver may include, but is not limited to, an antenna, a radio frequency (RF) transceiver, one or more amplifiers, Analog to digital converter, one or more oscillators, a digital signal processor, a Universal Serial Bus (USB) device, a coder-decoder (CODEC) chipset, and/or a local buffer. In alternate embodiment, the transceiver may communicate with the one or more first sensors 126a, 126b, 126c, and 126d, and the one or more second sensors 128a, 128b, and 128c through networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

Further, the engine idling reduction system 124 is configured to monitor one or more second parameters associated with the engine 102 and the one or more components. In an embodiment, the engine idling reduction system 124 utilizes the one or more second sensors 128a, 128b and 128c to monitor the one or more second parameters. In an embodiment, the second sensors 128a, and 128b are installed in the engine 102 to measure a speed of the engine 102 and a load on the engine 102. Further, the second sensor 128c is installed in the transmission assembly 110 to determine the gear engaged in the transmission assembly 110. Based on the monitoring of the first parameter and the one or more second parameters, the engine idling reduction system 124 operates the engine 102. In an embodiment, the operation of the engine idling reduction system 124 has been described later in conjunction with FIGS. 3a, 3b, 3c, and FIG. 4. Further, the structure of the engine idling reduction system 124 has been described in conjunction with FIG. 2.

Referring to FIG. 2, the engine idling reduction system 124 is illustrated. The engine idling reduction system 124 includes a controller 130, the one or more first sensors 126a, 126b, 126c, and 126d, and the one or more second sensors 128a, 128b, and 128c, and an alarm device 132.

The alarm device 132 is configured to raise an alarm or a notification for the bystanders near the engine 102. In an embodiment, the alarm may be an audio alarm or a visual alarm. In a scenario, where the alarm corresponds to the audio alarm, the alarm device 132 may correspond to a speaker that generates a predefined audio signal based on the instruction received from the controller 130. In a scenario, where the alarm corresponds to a visual alarm, the alarm device 132 may correspond to a display device. The display device may be a LCD display, LED display or a 7-segment display. Further, alarm device 132 may receive an instruction from the controller 130 to display a predetermined message. In another embodiment, the alarm device 132 may be configured to generate an alarm, which is a combination of both audio and visual alarm. In such a scenario, the alarm device 132 may include both the speaker and the display device.

### INDUSTRIAL APPLICABILITY

Referring to FIGS. 3a, 3b, 3c and FIG. 4, a flowchart 300 illustrating a method to operate the engine 102 and the state diagram 400 illustrates various states of operation of the engine 102 are illustrated, respectively.

At step 302, the engine 102 is started. In an embodiment, the controller 130 is configured to start the engine 102 using the first starter motor 120. In an embodiment, the pressurized fluid is used to operate the first starter motor 120, which in turn starts the engine 102. After the engine 102 is started, the engine 102 operates in the state 402 (refer FIG. 4). In an embodiment, the state 402 represents a normal engine running state.

At step 304, the measure of the one or more second parameters associated with the engine 102 and the one or more components coupled to the engine 102, is received. In an embodiment, the controller 130 is configured to receive the measure of the one or more second parameters. As discussed above, the one or more second parameters include the speed of the engine 102, the load on the engine 102, and the gear engaged in the transmission assembly 110. In an embodiment, the second sensor 128a determines the measure of speed of the engine 102. In an embodiment, the speed of the engine 102 corresponds to a rotational speed of the crankshaft. In an embodiment, the second sensor 128b determines the measure of the load on the engine 102. In an embodiment, the second sensor 128c determines the type of the gear engaged in the transmission assembly 110. In an embodiment, the controller 130 is configured to receive the measure of the one or more second parameters from the one or more second sensors 128a, 128b, and 128c.

At step 306, a check is performed to determine whether the speed of the engine 102 is less than a predetermined threshold of the speed. In an embodiment, the controller 130 performs the check. If the controller 130 determines that the speed of the engine 102 is less than the predetermined threshold of speed, the controller 130 performs the step 308. Else, the controller 130 repeats the step 304.

At step 308, a check is performed to determine whether the load on the engine 102 is less than a predetermined threshold of the load. In an embodiment, the controller 130 performs the check. If the controller 130 determines that the load on the engine 102 is less than the predetermined threshold of the load, the controller 130 performs the step 310. Else, the controller 130 repeats the step 304.

At step 310, a check is performed to determine whether the gear engaged in the transmission assembly 110 is neutral gear. In an embodiment, the controller 130 performs the check. If the controller 130 determines that the gear engaged in the transmission assembly 110 is neutral gear, the controller 130 performs the step 312. Else, the controller 130 repeats the step 304.

Additionally, in an embodiment, the controller 130 may be further configured to check if the brakes in the transmission assembly 110 are in a locked state by utilizing the second sensor 128c. If the brakes are in the locked state and the gear engaged in the transmission assembly 110 is neutral gear, the controller 130 performs the step 312.

At step 312, a check is performed to determine whether a time period, for which the measure of the one or more second parameters is less than the respective predetermined threshold values, is greater than a predetermined first time interval. In an embodiment, the controller 130 is configured to perform the check. In an embodiment, the check (in the step 312) is performed to ascertain that the measure of the one or more second parameters associated with each of the engine 102 and the one or more components, is less than or equal to the respective predetermined threshold values for the predetermined first time interval. If at the step 312, it is determined that the time period is less than the predetermined first time interval, the step 304 is repeated. Else, the step 314 is performed.

In some embodiments, different time intervals for each of the one or more second parameters may be defined. For example, the controller 130 may perform a check whether the measure of the engine speed is less than the predetermined threshold value of the speed, for 15 seconds. In addition, the controller 130 may perform a check whether the load on the engine 102 is less than predetermined threshold of load, for 10 seconds.

At step 314, the engine idling reduction mode (EIRM) is activated. In an embodiment, the controller 130 is configured to activate the EIRM (depicted by 404). When the engine idling reduction mode is activated, the engine 102 operates in the state 406. In an embodiment, the state 406 represents that the engine 102 is on and the EIRM is active.

In some embodiments, the controller 130 may perform the steps 306 to 310 in any order without departing from the scope of the disclosure. Further, in an embodiment, the steps 306 to 310 may be performed in parallel. Further, it can be observed that EIRM is activated only when measure of each of the one or more second parameters associated with the engine 102 and the one or more components less than or equal to the respective predetermined threshold values for the first predetermined first time interval. For instance, let the predetermined threshold of the engine speed is 900 rpm, the predetermined threshold of the engine load is 10%, the gear that should be engaged is neutral, and the predetermined first time interval is 15 seconds. If the controller 130 determines that, for a time period greater than 15 seconds, the measure of the engine speed is 700 rpm, the measure of the engine load is 5%, and the type of the gear engaged is neutral gear, the controller 130 activates the EIRM. However, if the measure of the engine speed is 1000 rpm and the measure of remaining second parameters is same, the controller 130 will not activate the EIRM.

At step 316, the alarm device 132 is activated, when the EIRM is activated. In an embodiment, the controller 130 is configured to activate the alarm device 132. On activation of the alarm device 132, the alarm device 132 may generate at least one of the predetermined audio signal or the predetermined visual signal. The audio signal or the visual signal warns the bystanders near the engine 102 to remain vigilant and careful, as the engine 102 is still operational.

At step 318, the measure of the first parameter associated with each of the one or more components coupled to the engine 102, is received. In an embodiment, the controller 130 is configured to receive the measure of the first parameter. As discussed above, the first parameter includes the temperature of the coolant in the engine cooling unit 114, the temperature of the inlet 129 of the turbine 127 in the turbocharger 112, the temperature of the oil in the transmission assembly 110, and the SOC of the battery 116. In an embodiment, the controller 130 receives the measure of the temperature of the coolant in the engine-cooling unit 114, the measure of the temperature of the inlet 129 of the turbine 127 in the turbocharger 112, the measure of the temperature of oil in the transmission assembly 110 from the first sensors 126a, 126b, and 126c, respectively. In an embodiment, the controller 130 receives the measure of the SOC of the battery 116 from the first sensor 126d.

At step 320, a check is performed to determine whether the measure of the first parameter associated with each of the one or more components is within respective predetermined ranges. In an embodiment, the controller 130 is configured to perform the check. If the controller 130 determines that the measure of the first parameter associated with each of the one or more components is within the respective predetermined ranges, the step 322 is performed. Therefore, the controller 130 will perform the step 322 only if the measure of the temperature of the coolant, the temperature of the inlet 129 of the turbine 127, the temperature of oil in the transmission assembly 110, and the measure of the SOC of the battery 116, are within their respective predetermined ranges. Else, the controller 130 repeats the step 318.

Additionally, at step 320, the controller 130 may determine the whether the measure of the first parameter associated with the equipment external to the engine system 100 is within the respective predetermined range. For example, the equipment external to the engine system 100 corresponds to the frac pump. As discussed supra that the first parameter associated with the frac pump may include at least the temperature of the frac pump and the hydraulic pressure of the fluid in the frac pump. If the controller 130 determines that the measure of the first parameter associated with the equipment external to the engine system 100, and the measure of the first parameter associated with the one or more components, are within respective predetermined ranges, the controller 130 performs the step 322.

For example, let the predetermined range of temperature of the oil in the transmission assembly 110 is 100° C.-200° C., the predetermined range of temperature of the inlet of the turbine 127 of the turbocharger 112 is 150° C.-200° C., the predetermined range of temperature of the coolant is 50° C.-100° C., the predetermined range of SOC of battery 116 is 15%-30%, the predetermined range of temperature of frac pump is 50° C.-100° C., and the predetermined range of pressure of fluid in frac pump is 500 PSI-1000 PSI. If the controller 130 determines that the temperature of the oil in the transmission assembly 110 is 110° C., the temperature of the inlet 129 of the turbocharger 112 is 175° C., the temperature of the coolant is 60° C., the SOC of the battery 116 is 20%, the temperature of the frac pump is 75° C., and the pressure of the fluid in the frac pump is 755 PSI, the controller 130 may perform the step 322. However, if the measure the first parameter associated with any of the component is not within the respective predetermined ranges, the controller 130 will repeat the step 318. For example, if the measure of the oil in the transmission assembly 110 is 90° C., the controller 130 will repeat the step 318.

At step 322, the engine 102 is de-rated. In an embodiment, the controller 130 is configured to de-rate the engine 102 for a predetermined second time interval. In an embodiment, the step 322 is optional. In such a scenario, the controller 130 may directly perform the step 324 after the step 320.

At step 324, the engine 102 is shut down. In an embodiment, the controller 130 is configured to shut down the engine 102 (represented by 408). In an embodiment, the controller 130 shuts down the engine 102 after the expiration of the predetermined second time interval and if the check performed in the steps 320 and 322 are true. The controller 130 keeps the EIRM activated even after the shut down of the engine 102. As the engine 102 is shut down and the EIRM mode is active, the state of operation of the engine 102 is represented by the state 410.

After the engine 102 is shut down and the EIRM is active, at step 326, a check is performed to determine whether the measure of the first parameter associated with at least one of the one or more components is less than respective predetermined threshold values. In an embodiment, the controller 130 is configured to perform the check. If the controller 130 determines that the measure of the first parameter associated with any one of the one or more components is less the respective predetermined threshold values, the controller 130 performs the step 328. Else, the controller 130 repeats the step 326.

For example, let the predetermined threshold of the temperature of the oil in the transmission assembly 110 is 90° C., the predetermined threshold of the temperature of the coolant is 90° C., and the predetermined threshold of SOC of the battery 116 is 5%. If the controller 130 determines that the temperature of the oil in the transmission assembly 110 is 89° C., which is below the threshold value 90° C., the controller 130 perform the step 328 irrespective of the measure of the first parameter associated with other one or more components.

Additionally, the controller 130 may determine if the first parameter associated with the equipment external to the engine system 100 is less than a respective threshold value. For instance, the controller 130 may check if the measure of pressure of fluid of the frac pump is less than the predetermined threshold value. If the controller 130 determines that the measure of the first parameter associated with the equipment, external to the engine system 100, is less than the respective predetermined threshold value, the controller 130 perform the step 328.

At step 328, the engine 102 is started. In an embodiment, the controller 130 is configured to start the engine 102 (represented by 412). In an embodiment, the controller 130 starts the engine 102 using the second starter motor 122. The controller 130 utilizes the battery 116 to operate the second starter motor 122, which in turn starts the engine 102. When the engine 102 is ON and the EIRM is active, the engine 102 operates in the state 406.

In a scenario, when the engine 102 is operating in the state 410 or state 406 (i.e., EIRM is active) and the operator of the engine 102 wants to operate the engine 102, the operator may provide an instruction to start the engine 102. For example, the operator may provide the instruction by engaging a gear other than the neutral gear in the transmission assembly 110. In such a scenario, the EIRM is deactivated and the engine 102 operates in the normal engine running state 402. In an embodiment, if the state of operation of the engine 102 is 406 before the receipt of the instruction from the operator, the only the EIRM is deactivated (represented by 414). Therefore, the state of the operation of the engine 102 is switched to the state 402. In an embodiment, if the state of operation of the engine 102 is 410 before the receipt of the instruction from the operator, the engine 102 is started using the second starter motor 122 and the EIRM is deactivated (represented by 416). Further, the engine 102 operates in the state 402.

Further, in another scenario, if the operator wants to completely shut down the engine 102, the operator may provide an instruction to completely shut down the engine 102. In such a scenario, both the EIRM and the engine 102 are shut down (represented by 418). Further, the engine 102 operates in the state 420.

The disclosed embodiment encompass numerous advantages. As when the engine 102 is idling, the EIRM is activated. When the EIRM is active, the engine 102 is started and shut down intermittently based on the measure of the first parameter associated with each of the one or more components coupled to the engine 102. Therefore, fuel consumption is reduced. Further, as the engine 102 is switched ON and OFF based on the temperature of the one or more components such that the temperature of the one or more components does not fall below the predetermined threshold, whenever the operator wants to operate the engine 102, the engine temperature and the temperature of the one or more components will be conducive for easy start of the engine 102. Additionally, as discussed supra, the temperature of the equipment, external to the engine system 100, is also monitored so that easy restart of these equipment is also considered.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for operating an engine, the method comprising:
activating an engine idling reduction mode;
when the engine idling reduction mode is active:
shutting down the engine when a measure of at least one first parameter, associated with each of one or more components coupled to the engine, is in respective predetermined ranges, wherein the one or more components comprise at least a transmission assembly, and wherein the at least one first parameter corresponds to a temperature of oil in the transmission assembly; and
starting the engine when the measure of the at least one first parameter, associated with at least one of the one or more components, is less than respective predetermined threshold values.

2. The method of claim 1, wherein the engine idling reduction mode is activated based on a measure of one or more second parameters associated with the engine and the one or more components.

3. The method of claim 2, wherein the one or more second parameters comprise a speed of the engine, a load on the engine, a gear engaged in the transmission assembly.

4. The method of claim 3, wherein the engine idling reduction mode is activated when, for a predetermined first time interval, a measure of the speed of the engine is less than a predetermined threshold of the speed of the engine, a measure of load on the engine is less than a predetermined threshold of the load, and the gear engaged in the transmission assembly is a neutral gear.

5. The method of claim 1, wherein the one or more components further comprise a turbocharger, a battery and an engine cooling unit.

6. The method of claim 5, wherein the at least one first parameter further corresponds to a temperature of a coolant in the engine cooling unit, a temperature of an inlet of a turbine in the turbocharger, and a state of charge of the battery.

7. The method of claim 6, wherein the engine is shut down when the temperature of the coolant, the temperature of the inlet of the turbine in the turbocharger, the temperature of the oil, and the state of charge of the battery, are in the respective predetermined ranges.

8. The method of claim 1 further comprising de-rating the engine for a predetermined second time interval, prior to the shut down of the engine, based on the measure of the at least one first parameter.

9. The method of claim 1 further comprising activating an alarm device when the engine idling reduction mode is activated, wherein the alarm device is utilized to warns bystanders to be cautious as the engine is operating in the engine idling reduction mode.

10. The method of claim 1, wherein when the engine is switched off and the engine idling reduction mode is deactivated, the engine is started using a first starter motor.

11. The method of claim 10, wherein when the engine idling reduction mode is activated, the engine is started using a second starter motor, wherein the second starter motor is different from the first starter motor.

12. The method of claim 1 further comprising deactivating the engine idling reduction mode when an instruction is received by an operator of the engine, wherein the instruction corresponds to at least an engagement of a gear other than a neutral gear in the transmission assembly.

13. An engine system comprising:
an engine;
one or more components coupled to the engine; and
an engine idling reduction system comprising a controller configured to:
activate an engine idling reduction mode,
when the engine idling reduction mode is active:
shut down the engine when a measure of at least one first parameter, associated with each of the one or more components, is in respective predetermined ranges, wherein the one or more components comprise at least a transmission assembly, and wherein the at least one first parameter corresponds to a temperature of oil in the transmission assembly, and
start the engine when the measure of the at least one first parameter, associated with at least one of the one or more components, is less than respective predetermined threshold values.

14. The engine system of claim 13, wherein the one or more components further comprise a turbocharger, a battery and an engine cooling unit.

15. The engine system of claim 14 further comprising one or more first sensors installed in each of the one or more components, wherein the one or more first sensors are configured to measure the at least one first parameter associated with each of the one or more components.

16. The engine system of claim 14, wherein the engine idling reduction mode is activated when, for a predetermined first time interval, a measure of a speed of the engine is less than a predetermined threshold of the speed of the engine, a measure of a load on the engine is less than a predetermined threshold of the load, and a gear engaged in the transmission assembly is a neutral gear.

17. An engine idling reduction system comprising:
one or more first sensors configured to determine a measure of at least one first parameter associated with one or more components coupled to an engine, wherein the one or more components comprise at least a transmission assembly, and wherein the at least one first parameter corresponds to at least a measure of a temperature of oil in the transmission assembly;
a controller configured to:
activate an engine idling reduction mode,
when the engine idling reduction mode is active:
shut down the engine when the measure of the at least one first parameter, associated with each of the one or more components, is in respective predetermined ranges, and
start the engine when the measure of the at least one first parameter, associated with at least one of the one or more components, is less than respective predetermined threshold values.

18. The engine idling reduction system of claim 17, wherein the one or more components further comprise a turbocharger, a battery and an engine cooling unit.

19. The engine idling reduction system of claim 17, wherein the engine idling reduction mode is activated when, for a predetermined first time interval, a measure of a speed of the engine is less than a predetermined threshold of the speed of the engine, a measure of a load on the engine is less than a predetermined threshold of the load, and a gear engaged in the transmission assembly is a neutral gear.

20. The engine idling reduction system of claim 17 further comprising an alarm device coupled to the controller, wherein the alarm device is activated when the engine idling reduction mode is activated, wherein the alarm device is used to warn bystanders to be cautious as the engine is operating in the engine idling reduction mode.
